(19) United States
(12) Patent Application Publication
(10) Pub. No.: US 2007/0112950 A1
(43) Pub. Date: May 17, 2007

(54) DOMAIN NAME EXPIRATION PROTECTION

(75) Inventor: Robert R. Parsons, Scottsdale, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 11/626,744

(22) Filed: Jan. 24, 2007

Related U.S. Application Data
(63) Continuation-in-part of application No. 10/811,677, filed on Mar. 29, 2004.
(63) Continuation-in-part of application No. 10/811,616, filed on Mar. 29, 2004.

(51) Int. Cl. G06F 15/173

(52) U.S. Cl. 709/223

(57) ABSTRACT

The present invention provides a method for a Facilitator to provide a domain name expiration protection service for an Entrepreneur. The Facilitator may renew the domain name for the Entrepreneur if the Entrepreneur has not renewed it himself. Further, the domain name expiration protection service may be bundled with domain name registration, website hosting, assistance in website design, assistance in store front website design, website copyright registration, domain name trademark registration, website promotion services, etc.

### CROSS REFERENCE TO RELATED PATENT APPLICATIONS

This application is a continuation-in-part of U.S. patent application Ser. No. 10/811,677 to Parsons et. al. filed on Mar. 29, 2004 and titled “METHOD FOR A FACILITATOR TO ASSIST AN ENTREPRENEUR IN CREATING AN INTERNET BUSINESS”. This application is a continuation-in-part of U.S. patent application Ser. No. 10/811,616 to Robert R. Parsons filed on Mar. 29, 2004 and titled “PROCESS FOR REGISTERING AND TRADEMARKING DOMAIN NAMES”. All prior applications are incorporated herein in their entirety by reference.

The subject matter of all patent applications is commonly owned and assigned to The Go Daddy Group, Inc.

### FIELD OF THE INVENTION

The present invention relates in general to domain name systems and methods and in particular to systems and methods for protecting domain names.

### BACKGROUND OF THE INVENTION

The Internet is a worldwide network of computers and computer networks arranged to allow the easy and robust exchange of information between users of computers. Hundreds of millions of people around the world have access to computers connected to the Internet via Internet Service Providers (ISPs). Content providers place multimedia information, i.e. text, graphics, sounds, and other forms of data, at specific locations on the Internet referred to as websites. The combination of all the websites and their corresponding webpages on the Internet is generally known as the World Wide Web (WWW) or simply web.

Websites may be created using Hypertext Markup Language (HTML). The HTML tags define how the webpages for the website are to be displayed. Users of the Internet may access content providers' websites using software known as a Web browser, such as MICROSOFT INTERNET EXPLORER or NETSCAPE NAVIGATOR. After the browser has located the desired webpage, it requests and receives information from the webpage, typically in the form of an HTML document, and then displays the webpage content for the user. The user may then view other webpages at the same website or move to an entirely different website using the browser.

Browsers are able to locate specific websites because each website, resource and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other, e.g. 64.202.167.32. The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon, for example 2EDC:BA98:0332:0000:CF8A:000C:2154:7313.

However, IP addresses, even in human readable notation, are difficult to remember and use by people. Uniform Resource Locators (URL) are much easier to remember and may be used to point to any website, directory or file on the Internet. A browser is able to access a website on the Internet through the use of a URL. The URL may include a Hypertext Transfer Protocol (HTTP) request combined with the website's Internet address, also known as the website's domain name. An example of a URL with an HTTP request and domain name is: http://godaddy.com. In this example, the “http” identifies the URL as an HTTP request and “godaddy.com” is the domain name.

Individuals, companies, and other entities that provide content on the web generally want to use their name or one of their trademarks as part of their domain name. Thus, domain names are generally company trademarks, personal names or short phrases concatenated with a top level domain name (TLD) extension (e.g. .com, .net, .org, .biz, .us, .cc, .ws, .de, etc.). TLD extensions can be divided into two groups. The first group is known as generic Top-Level Domains (gTLD) and the second group is country code TLDs (ccTLD). Examples of gTLDs include .com, .net, .org, .biz, etc. Examples of current ccTLDs are: .us for the United States, .uk and .gb for United Kingdom, .ca for Canada, .de for Germany, .jp for Japan, etc.

Domain names are much easier to remember and use than their corresponding IP addresses. The Internet Corporation for Assigned Names and Numbers (ICANN) approves some gTLDs and delegates the responsibility to a particular organization (hereinafter registry) for maintaining an authoritative source for the registered domain names within a TLD and their corresponding IP addresses. For certain TLDs, e.g. .biz, .info, .name, and .org, the registry is also the authoritative source for contact information related to the domain name and is referred to as a “thick” registry. For other TLDs, e.g. .com, .net, only the domain name and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org and some other TLDs allows a Customer to use an ICANN-accredited registrar. For example, if a Customer, John Doe, wishes to register the domain name “JohnDoe.com”, John Doe may initially determine whether the desired domain name is available by contacting a registrar. The Customer may make this contact using the registrar's webpage and typing the desired domain name into a field on the registrar's webpage created for this purpose. Upon receiving the request from the Customer, the registrar may ascertain whether “JohnDoe.com” has already been registered by checking the SRS database of the registry associated with the TLD of the domain name. The results of the search may then be displayed on the webpage to thereby notify the Customer of the availability of the domain name. If the domain name is available, the Customer may proceed with the registration process. Otherwise, the Customer may keep selecting alternative domain names until an available domain name is found.

Domain names are typically registered for a period of one to ten years. If the registrant does not renew the domain name, it will expire. Shortly after the domain name goes past its expiration date the domain name will be deactivated. All domain services including the webpage and email will no longer work. For approximately 40 days the domain name will be in a “grace period”. During this time the domain name will not be active and may be renewed without paying any additional fees. At the end of the grace period the domain name will enter a 30-day redemption period. WHOIS information (name, address, telephone numbers, etc.) will be deleted from the registry. The domain name may be renewed by its original owner for a fee during the redemption period. Five days after the end of the redemption period the domain name will be deleted from the registry and will be made available for anyone to register.

The Internet has already achieved global presence and continues to show fast growth. Entrepreneurs are rapidly creating websites to take advantage of the growing number of Customers using the Internet and Customers willingness to purchase goods and services over the Web. Websites created by Entrepreneurs may be reached by millions of Internet savvy Customers, thereby allowing Entrepreneurs to offer their products and services to a very large pool of potential Customers. The quality of the Entrepreneur's website is vital to the success of the Entrepreneur's Internet businesses as the website is the access point for Customers to purchase the Entrepreneur's goods and services.

Entrepreneurs trying to start an Internet business may include individuals starting a home Internet business, corporations designed specifically for operation on the Internet, or even existing corporations that are taking advantage of the popularity of the Internet to increase their sales with new and existing Customers. As the popularity of the Internet continues to increase with Customers, the number of new Entrepreneurs chasing Customers that use the Internet will also increase.

The process for starting an Internet business has many important steps and many of these steps require some specific technical knowledge or legal expertise to effectively complete. Small Entrepreneurs, and even many larger Entrepreneurs, typically do not have sufficient resources or expertise in each area to complete all the steps in the most effective manner. A mistake or poor implementation in any one of the steps at the time of creation of an Internet business may severally limit its later effectiveness.

Over time, the registered domain name may acquire considerable name recognition, good will and value for the Entrepreneur. A loyal Customer base may be built-up by the Entrepreneur that repeatedly accesses the Entrepreneur's website via the domain name. Maintaining control over the domain name, and preventing confusingly similar domain names from appearing on the Internet, will be important factors in the success of the Entrepreneur's Internet business.

The Entrepreneurs must protect their domain names. If the Entrepreneur allows the domain name registration period to lapse, the Entrepreneur may loose his domain name. Domain name may also be, inadvertently or fraudulently, transferred to another entity. Thus, the Entrepreneur must closely monitor domain name transfer requests and deny those that he does not recognize as valid. Therefore, there are new systems and methods needed that would help the Entrepreneurs protect their domain names from inadvertent expirations or transfers.

The Entrepreneur may receive important legal rights by trademarking the domain name with the United States Patent and Trademark Office (USPTO). For example, a trademarked domain name may receive additional legal protection under the Internet Corporation for Assigned Names and Numbers' (ICANN) Uniform Domain Name Dispute Resolution Policy, the Lanham Act and the Anti-Cybersquating Piracy Act. Thus, trademarking the domain name gives the Entrepreneur substantial legal rights to prevent others from using confusingly similar domain names to the Entrepreneur's trademarked domain name.

Entrepreneurs regularly register domain names with a Registrar that incorporate their existing trademarks. This usually occurs when the Entrepreneur has an existing traditional business and is expanding the business by creating an Internet presence. However, for many Entrepreneurs, their domain names have not been trademarked and therefore are not as fully protected as federally registered trademarked domain names.

Entrepreneurs often fail to trademark their domain names. There are a host of reasons for this. Some Entrepreneurs mistakenly believe that by registering their domain name with a domain name Registrar, the domain name is legally protected. Others are not aware of the many legal benefits of federally registering their domain names as trademarks. In addition, many Entrepreneurs are unfamiliar with the process for trademarking their domain names and they do not want to spend the time to learn the process or to pay an attorney to trademark their domain names for them. Applicants believe that many of these problems are the result of a lack of integration between the process for registering a domain name via a Registrar and the process for trademarking the domain name as a trademark with the USPTO.

Websites are mostly created using HTML. Designing a website in HTML, or any other computer language, may be a very laborious task that requires a high level of expertise and a substantial amount of time and effort. Designing a custom website requires a great deal of creativity, planning and computer expertise.

There are various products and tools commercially available to assist Entrepreneurs in designing their websites that allow Entrepreneurs, even with limited computer abilities, to design their own websites. The easiest website designing tools to use provide a plurality of templates that Entrepreneurs may select from. Once a template is chosen, the same template may be used for each webpage in the website. The Entrepreneurs may insert text or graphics into specific locations on the chosen template set aside for those features. Templates provide a uniform look and feel for each webpage within a website so that a Customer can tell that they are in the same website as they move from webpage to webpage within the website.

Entrepreneurs often want to display their products and services with corresponding prices on their websites. The Entrepreneurs also typically want a method of collecting information such as a shipping address and payment information from their Customers. Programming these features into the Entrepreneurs website, while certainly possible, requires a substantial amount of expertise and effort. Each Entrepreneur would have to duplicate this cumbersome task on their website. To simplify the process, some third party websites offer a shopping cart or store front website feature. Entrepreneurs initialize or set-up the store front by transmitting information regarding their goods and services (possible with graphics showing the goods), payment options/information and some display preference options to the website designed to create the store front website. A selection of templates may be made available to the Entrepreneur to assist the Entrepreneur in creating a visually appealing method of displaying their goods and services.

In practice, a Customer would connect to the Entrepreneur's website and then if interested in purchasing goods or services of the Entrepreneur, would select a hyperlink to a store front website as previously set-up by the Entrepreneur. The store front website allows the Customer to select and purchase goods and services and pay for them at which point the store front website may transfer the payment to the Entrepreneur. The Customer may then be linked back to the Entrepreneur's website after the completion or cancellation of the purchase.

Applicants have noticed that the templates used to design an Entrepreneur's website do not match the templates for designing a store front website. This prevents the Entrepreneur's website and the store front website from appearing as a single virtual website to Customers, thereby possibly confusing the Customers about the source of the goods and services they are purchasing.

Another problem for website designers is that their work, i.e. the creative aspects of their website, may be easily copied by competitors. The website code may be copied and pasted in mass to a competitor's website or the competitor may copy and recreate the layout to their website. The fact that websites are created using computer code that is very easily copied makes website's designs particularly vulnerable to being stolen.

The creation of a website on the Internet automatically provides some limited legal rights to the owner of the website in the United States. By inserting a copyright symbol, date and name of the owner of the website on the website, additional legal rights may be obtained. But for the Entrepreneur to receive the maximum legal protection for their website, they need to register, i.e. copyright, their website with the United States Copyright Office (USCO). Despite the legal advantages, only a very small percentage of websites ever get registered with the USCO.

The reasons that Entrepreneurs fail to copyright their websites with the USCO are as varied as the Entrepreneurs themselves, but the primary reasons tend to be similar to the reasons that Entrepreneurs fail to trademark their domain names. As examples, Entrepreneurs often do not appreciate the legal advantages of copyrighting their website, they do not understand the procedures for copyrighting their website and they do not want to pay an attorney to copyright their websites for them. Applicants believe that because conventional website development tools do not assist the Entrepreneurs in copyrighting their website with the USCO, many Entrepreneurs fail to fully legally protect the material within their website by copyrighting their websites.

Entrepreneur's websites may be hosted on servers that permit Customers to access the websites over the Internet. The amount of hosting space and bandwidth provided by the servers for use by the websites are typically two of the largest factors in determining the cost of the hosting services. Entrepreneurs often incorrectly estimate the amount of hosting services required by their Internet businesses, resulting in paying more for hosting services than necessary or running their Internet business with insufficient resources.

In order to increase revenue, Entrepreneurs typically try to attract additional Customers to their websites. However, with an ever increasing number of websites on the Internet, Entrepreneurs are finding it increasingly difficult to attract new Customers to their Internet business. This trend is likely to continue as the number of businesses trying to gain a presence on the Internet significantly increases the competition for the attention of Internet Customers. The future success for many of these Internet businesses will depend on their ability to attract additional Customers to their websites.

Websites are predominantly found by Internet Customers through the use of a search engine or online directory. Some of the more widely used search engines are, for example, AOL, Google, Yahoo, Excite, and Dogpile. Customers are able to enter a search phrase comprised of one or more keywords or a phrase, typically a name of a good or service or a topic of interest, into a search engine. The search engine will display a list of websites that the search engine has determined are related to the search phrase along with links to the websites. The search engines invariably display the websites in a particular order or rank. The websites that the search engine has determined are of the highest quality or are the websites with content most closely related to the search phrase of the Customer are displayed near the top, while lower quality websites or those not as closely related to the search phrase are displayed lower on the list. The shear number of websites currently on the Internet can often result in a list having multiple pages of websites related to many common search phrases.

In an effort to increase traffic flow to their websites, sophisticated Entrepreneurs register their websites with one or more search engines. However, most Entrepreneurs are unfamiliar with the registration process, and even those that are familiar with the process often find it difficult and time consuming to register their websites with a plurality of different search engines. Thus, many websites do not receive as many Customers as they would if they were registered on a greater number of search engines.

Another common method to drive Customers to an Entrepreneur's website is through targeted email campaigns. Many Entrepreneur's websites allow a Customer to create an account. During the account creation process, sites may allow a Customer to specify if the Customer would like to be notified of any future specials or sales. Targeted marketing campaigns may then be created from the customer accounts that help drive traffic to the Entrepreneur's website. However, Applicants have noticed that these targeted marketing campaigns do not have a similar appearance with the Entrepreneur's Website and thus confuse the Customer as to the source of the marketing information.

There are thus many advantageous steps that an Entrepreneur may take to protect their intellectual property and to enhance the commercial success of their Internet business. One of the main hurdles for the Entrepreneur is to complete all or as many of the steps as possible. Each step offers specific advantages while the failure to complete a step may have a detrimental effect on the eventual success of the Internet business.

There are many problems for Entrepreneurs to deal with in creating an Internet business. For example, many Entrepreneurs are not even aware of all the above described beneficial steps, let alone the best order to complete the steps in. Even if they are aware of the steps, they may be unable to find the plurality of different websites needed to complete the above recommended steps. Even after the websites have been located, the process for completing the steps may be very complicated and often require special technical or legal knowledge. In the prior art, the Entrepreneurs had to locate all the websites themselves and complete the desired steps without any overall guidance.

The challenge for Entrepreneurs is compounded by the fact that some of the websites necessary to complete the above described steps are general in nature and not specifically created to assist Entrepreneurs in developing their Internet businesses. As examples, the websites for the USPTO and the USCO have general purpose procedures since they must provide guidance to a wide variety of individuals using their services and are not able to provide specific instructions for users trademarking their domain names or copyrighting their websites.

To further exasperate the problem for Entrepreneurs, the failure to complete any one or more steps previously outlined may have serious consequences for the Entrepreneur's Internet business. As specific examples, the consequences may be that the Entrepreneur's domain names are not properly protected, the important intellectual property rights are not fully secured, the level of traffic to the Entrepreneur's website may be restricted or the Entrepreneur's website may be inadvertently contributing to identity theft. Therefore, there is a need for Entrepreneurs to more easily and inexpensively solve these problems.

New systems and processes are therefore needed to protect an Entrepreneur's domain name, attract Customers, and increase traffic flow to the Entrepreneur's websites that overcome the limitations of current methods. Thus, there remains a need for systems and processes which reduce or eliminate the problems associated with the conventional methods. Specifically, systems and processes are needed to assist Entrepreneurs in protecting their domain names.

### SUMMARY OF THE INVENTION

A Facilitator may create a website to assist Entrepreneurs in starting an Internet business. The Facilitator's website may provide guidance to Entrepreneurs regarding the entire Internet business creation process, such as describing the benefits for each step, the actions necessary to complete each step and providing a recommended order for completing the steps. In addition, the Facilitator's website may provide the tools for Entrepreneurs to successfully complete the steps necessary to start the Internet business. Accomplishing multiple steps at a single website solves many of the problems Entrepreneurs experience with prior art methods. By providing a plurality of powerful tools for creating an Internet business that are all integrated in a single website takes away the burden from the Entrepreneur in having to locate all these tools on various websites spread across the Internet.

Synergizes may be obtained by completing the steps in a logical order and by completing the steps within a shorter time-frame than with conventional methods. Specifically, by providing overall guidance to the Entrepreneur and by providing the tools necessary to create the Internet business all at one website, there is a much greater chance that all of the steps will be successfully completed and in a much shorter time than compared with prior art methods.

Another advantage of the invention is that information gathered during an earlier step may be saved and then used in completing later steps. This greatly reduces the frustration for Entrepreneurs of reentering the same information over and over during the creation of their Internet business. This advantage may still occur even if the Entrepreneur completes the later steps months or even years later. Saving data and using it for later steps also reduces the chance of errors in the later used data.

Entrepreneurs may reach the Facilitator's website via the Internet using, for example, their own computer systems. Once connected to the Facilitator's website, the Entrepreneur may register an available domain name with the assistance of the Facilitator's website. The Facilitator's website may verify that the requested domain name is available and possibly even suggest alternative domain names. In a preferred embodiment, the Facilitator's website is operated by a domain name Registrar or a Reseller of a Registrar. A Facilitator that is also a Registrar or a Reseller of a Registrar of domain names will have the necessary infrastructure in place to register available domain names for Entrepreneurs.

The Facilitator's website may further provide products and services for protecting the Entrepreneur's domain name. The Entrepreneur may either purchase these products and services or they may be included in the package of products and services provided by the Facilitator's website to the Entrepreneur. The domain name protection services may include automatic renewal of Entrepreneur's domain name if the Entrepreneur did not renew the name on its own. In a sample embodiment, the Facilitator may renew the Entrepreneur's domain name in the Facilitator's name and then transfer it back to the Entrepreneur after the Entrepreneur reimburses the Facilitator for the renewal and other fees.

The Facilitator's website may assist the Entrepreneur in designing an Entrepreneur's website by providing website design services. The website design services may include software packages that are downloaded to the Entrepreneur's computer, but are preferably software packages run on the Facilitator's website. The website design services may provide templates for building website pages or a drag and drop approach that allows custom website pages to be created. Templates may offer various layouts for items such as navigational bars/menus, graphical images and textual content where their size, appearance and location may all be defined.

The Facilitator's website may also offer an electronic commerce (shopping cart) feature as part of a store front website integrated with the Entrepreneur's website. The store front website feature may be used to allow Customers to select and pay for goods and services offered by the Entrepreneur. By sharing a common template, the Facilitator's website and the shopping cart website may appear as one virtual website to Customers, when in fact the Entrepreneur's website and the store front website may be two distinct websites. In practice, a Customer would first access the Entrepreneur's website and the Entrepreneur may then link to the store front website where the Customer could select and purchase the goods and services offered by the Entrepreneur. Sharing a common appearance between the Entrepreneur's website and the store front website gives confidence to the Customer that they are buying the goods and services from the Entrepreneur and not from a third party hosting the store front website. The Facilitator's website may provide an integrated solution including providing a secure certificate, a merchant account and a payment gateway account. In a preferred embodiment, the Facilitator's website will also support any of the Entrepreneur's existing payment options listed above.

Once the Entrepreneur's website has been created (it should be noted that edits, updates and changes will likely be made to the Entrepreneur's website throughout its life), the Facilitator's website may arrange hosting services for the Entrepreneur's website. In a preferred embodiment of the invention, the Facilitator's website assists the Entrepreneur in selecting hosting options appropriate for the anticipated business volume of the Entrepreneur's website. The Facilitator may ask questions of the Entrepreneur to be able to calculate the Internet volume the website is likely to receive and recommend a level of hosting services appropriate for the expected volume. As examples, the amount of disk space and bandwidth provided to the Entrepreneur's website may be recommended to give the Entrepreneur's website the resources it needs without incurring costs for services it does not need.

A common problem for Entrepreneurs involves protecting the intellectual property of the content of their website. Compounding the problem is that websites are extremely easy to copy and the ubiquitous, but incorrect, belief that anything on the Internet is in the public domain and may be copied. The Facilitator's website may be used to assist the Entrepreneur in copyrighting all or some portion of the content of the Entrepreneur's website with the USCO. This greatly enhances the legal rights of the Entrepreneur to the intellectual property of the contents of their website.

Another common problem for Entrepreneurs involves protecting their registered domain names. Unscrupulous individuals may try to register confusingly similar domain names in a bad faith attempt to profit from confusion between the domain names and the good will generated by the Entrepreneur in their domain name. The Facilitator's website may assist Entrepreneur in trademarking the Entrepreneur's domain name with the USPTO. In a preferred embodiment, the Entrepreneur's domain name is trademarked after the Entrepreneur's website has been designed and hosted, i.e. after the trademark has been used in interstate commerce. While the domain name may be trademarked before being used in interstate commerce, waiting to trademark the domain name after commercial use allows for a simpler and less expensive application process to be used in trademarking the domain name. Specifically, a Use In Commerce application may be filed instead of an Intent To Use application, thereby avoiding the fee and the paper work associated with filing a Statement of Use form that is only required for Intent To Use applications. On the other hand, registering the trademark before openly using the trademark prevents unscrupulous individuals from trying to register the trademark before the Entrepreneur.

A typical objective for most Entrepreneurs is to get as many Customers as possible to visit their website. After all, Entrepreneur's websites that are not accessed by Customers have little economic value. Using a domain name that is easy to remember and easy to spell helps, but Customers often use search engines to locate the websites that they visit. The Facilitator's website may be used to submit the Entrepreneur's website (and even individual webpages) to one or more search engines to assist in increasing the number of Customers that access the Entrepreneur's website. The Facilitator's website may also recommend or even make changes to the Entrepreneur's website to assist the Entrepreneur's website's ability to be found by search engines.

To assist the Entrepreneur in submitting all of the products in their catalog to the various search engines, the Facilitator's website may allow Entrepreneurs to send targeted marketing campaigns to the Entrepreneurs' customer data. One form of targeted marketing is email campaigns. The Facilitator's website may allow Entrepreneurs to compile a list of relevant Customers to send marketing information to. In a preferred embodiment, the marketing information would contain the same look and feel as the Entrepreneur's websites to instill confidence and increases the chances of a sale with the Customer.

Additional advantages and aspects of the present invention will become apparent in the following detailed description of the invention and the claims.

### BRIEF DESCRIPTION OF THE DRAWINGS

FIG. 1 is a diagram illustrating the relationship between various components for an embodiment of the invention.

FIG. 2 is a flowchart illustrating an overall generic process for an embodiment of the invention.

FIG. 3 is a flowchart illustrating an embodiment of the invention for designing a website and a store front website that share a substantially similar layout.

FIG. 4 is a flowchart illustrating an embodiment of the invention for designing a website and copyrighting the website with the United States Copyright Office.

FIG. 5 is a flowchart illustrating an embodiment of the invention for registering a domain name with a Registry and trademarking the domain name with the USPTO.

FIG. 6 is a flowchart illustrating another embodiment of the invention for registering a domain name with a Registry and trademarking the domain name with the USPTO.

FIG. 7 is a flowchart illustrating another embodiment of the invention for registering a domain name with a Registry and trademarking the domain name with the USPTO.

FIG. 8 is a flowchart illustrating an embodiment of the invention for domain name expiration protection.

FIG. 9 is a flowchart illustrating an embodiment of the invention for combining domain name expiration protection with other services.

FIG. 10 is a flowchart illustrating an embodiment of the invention for domain name expiration protection and auto-renewal service.

### DETAILED DESCRIPTION AND PREFERRED EMBODIMENT

The present invention will now be discussed in detail with regard to the attached drawing figures which were briefly described above. In the following description, numerous specific details are set forth illustrating Applicant's best mode for practicing the invention and for enabling one of ordinary skill in the art to make and use the invention. It will be obvious, however, to one skilled in the art that the present invention may be practiced without many of these specific details. In other instances, well-known machines and process steps have not been described in particular detail in order to avoid unnecessarily obscuring the present invention. Unless otherwise indicated, like parts and processes are referred to with like reference numerals.

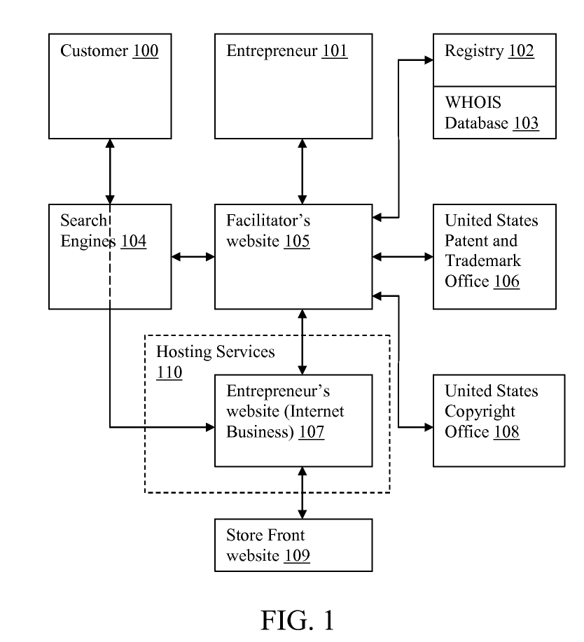

The general features used in practicing the invention and their interrelationships will be discussed with reference to FIG. 1. The invention includes various steps that may be performed by an Entrepreneur 101 at a Facilitator's website 105 to create an Entrepreneur's website 107 that acts as an Internet access point to the Entrepreneur's Internet business. The placement of a plurality of tools on a Facilitator's website 105 that may be helpful for creating an Internet business greatly assists the Entrepreneur 101 in completing more of the recommended steps and completing the steps in a much shorter time frame than with the ad hoc approach used by Entrepreneurs in the prior art.

The invention may be used by a wide variety of individuals and businesses, thus the term Entrepreneur as used to describe the present invention should be given a very broad meaning. As non-limiting examples, the term Entrepreneur may include an individual, a partnership, a corporation, a non-profit organization, a start-up business and an existing business looking to create an Internet presence.

The invention is not limited to any particular type of business, other than the business will conduct at least some part of its operation on a global computer network, such as the Internet. The word business should be interpret broadly and may include, inter alia, commercial and non-commercial activity, hobbies, interest groups, family activities, providing free informational resources to the public, etc. In preferred embodiments, the goods and services of the Entrepreneur 101 may be described and sold to Customer 100 who accesses the Entrepreneur's website 107. However, the Entrepreneur's website 107 may be more limited and use only for business activities such as public relations, new product announcements, marketing, consumer surveys or public service announcements.

Domain names have an associated Internet protocol addresses that is managed by the Domain Name System (DNS). The DNS is a distributed database that provides the protocol which allows Customers or other Internet users to locate various websites on the Internet based on the website's domain name. Web browsers are able to access the DNS to determine the Internet protocol address for a particular website, thereby allowing website browsers to locate the desired website for the Customer. The DNS allows a website to change its hosting service provider, and thus its Internet protocol address, but to keep its domain name with a new hosting service provider by simply updating the DNS with the website's new Internet protocol address assigned to it by its new hosting service provider.

The DNS uses a hierarchical naming scheme whereby various labels are separated by a period, commonly referred to as a “dot”, to form domain names. The characters on the far right side of the domain name are referred to as the Top-level Domain (TLD). Common TLDs include “.com” (commercial), “.net” (networking provider), “.org” (non-profit and miscellaneous organizations), “.us” (United States), “.info” (information resources), “.gov” (U.S. government) and “.edu” (U.S. educational institutions). Many other TLDs exist and additional new ones are added to the DNS from time to time. An illustrative example of a domain name is “trademark.com” where “trademark” may be considered the label and “.com” is the TLD. The Entrepreneur 101 may find it desirable to trademark the label portion, the entire domain name or both. For this example, the Entrepreneur may wish to trademark “trademark”, “trademark.com” or both.

The Internet is comprised of interconnected websites that are accessed by Users, such as Customers 100 and Entrepreneurs 101. Websites are typically hosted by a website hosting service and Users are typically provided access to the Internet by an Internet Service Provider. A User may move between website pages within a website or may “surf” the Internet by moving from one website to another website, typically with the assistance of a browser. Browsers offer several methods for Users to move within the Internet, such as having a “Favorites” menu to select a particular URL and providing an Address line for manually typing in a desired URL. Both features allow Users to quickly move between various websites and their associated webpages on the Internet.

Hyperlinks are another powerful method for Users to move around the Internet. A hyperlink includes text or a graphical image capable of moving a User to a predetermined webpage on the Internet with the click of a mouse. Hyperlinks may be created from menu items, graphical images, icons or text passages and when the hyperlink is selected the User moves or “links” to another webpage that may or may not be part of the currently accessed website. Text hyperlinks are generally written in blue and underlined to let the User know that the text is a hyperlink. Hyperlinks are a powerful tool in creating websites as they allow a website designer to assist a User in moving from webpage to webpage in a logical order. Hyperlinks may be used to move from webpage to webpage even when the webpages are not part of the same website.

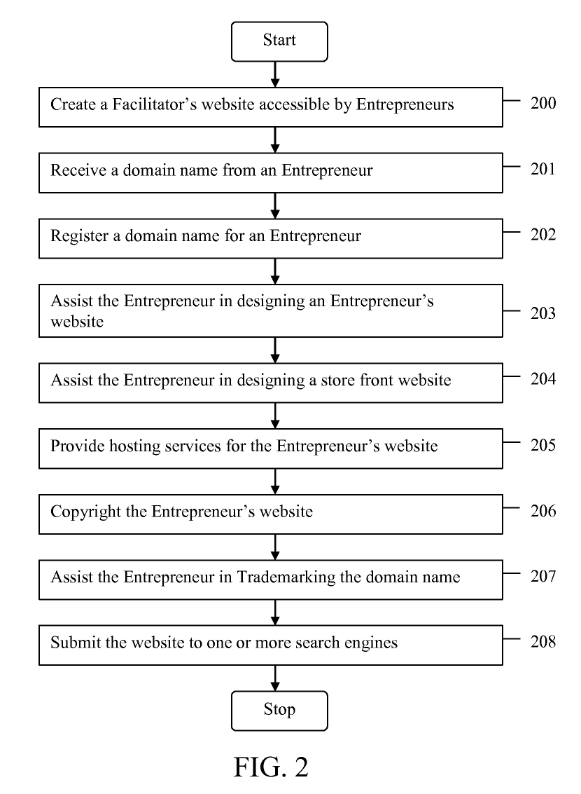

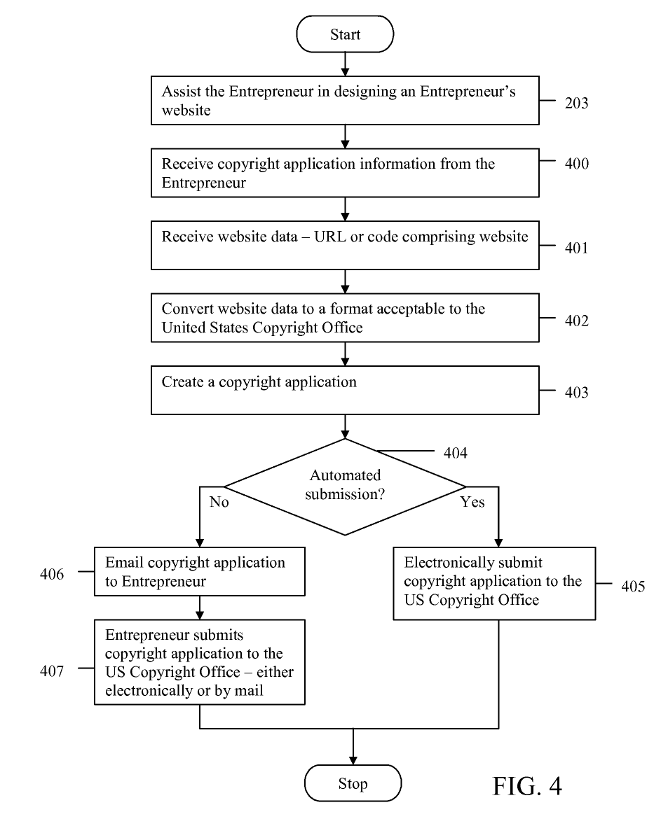

Various possible embodiments of the invention are illustrated in the flowcharts of FIGS. 2-7 and the steps for these embodiments will now be discussed in greater detail. A Facilitator may offer one or more recommended services for Entrepreneurs 101 to start their own Internet businesses 107 on a Facilitator's website 105 (Step 200). In a preferred embodiment, the Facilitator may be a Registry, Registrar or Reseller of domain names as this will allow the Facilitator to easily check on the availability of various domain names and to register available domain names for Entrepreneurs 101. The Facilitator may offer its service to the Entrepreneur 101 via its Facilitator's website 105 on the Internet. Placing the Facilitator's website 105 on the Internet allows for easy and convenient access by a large number of Entrepreneurs 101 and allows the Facilitator's website 105 to have easy access to other websites that are useful in creating the Entrepreneur's Internet business 107.

One of the advantages for the present invention over the prior art is that information regarding the Entrepreneur 101 only has to be collected once by the Facilitator's website and then it may be stored and used in multiple steps of the invention. Information regarding the Entrepreneur 101 may be requested either directly from the Entrepreneur 101 or from one of the many available on-line databases. The information may include, for example, the Entrepreneur's contact information so that this information does not have to be reentered by the Entrepreneur over and over. The information may be verified by the Entrepreneur 101 and then stored in memory that is accessible by the Facilitator's website 105. If the Entrepreneur 101 leaves the Facilitator's website 105, the information regarding the Entrepreneur 101 may be stored in a medium, such has a hard disk drive, useful for long term storage of data. The stored data may then be used when the Entrepreneur 101 accesses the Facilitator's website 105 at a later date.

Once connected to the Facilitator's website 105, the Entrepreneur 101 may register an available domain name. The Facilitator's website 105 may assist in this process by accepting a desired domain name from the Entrepreneur 101 (Step 201), informing the Entrepreneur 101 if the domain name is available, suggesting alternative available domain names based on input from the Entrepreneur 101, and registering a selected available domain name with the appropriate Registry 102 (Step 202). Entrepreneur's contact information and Entrepreneur's website DNS records will be stored in the WHOIS database 103.

The Facilitator's website 105 may assist the Entrepreneur 101 in selecting a domain name by evaluating the quality of one or more available domain names. The Facilitator's website 105 may evaluate the domain name for length (shorter is generally better) and how difficult it will be for the Customers 100 to remember and correctly spell the domain name. Other factors, such as the appropriateness of the domain name for the Entrepreneur's Internet business 107, may also be evaluated based on additional information provided by the Entrepreneur 101. Further details regarding the registration of domain names may be found in U.S. patent application Ser. No. 10/408,050 titled “METHOD FOR GATHERING DOMAIN NAME REGISTRATION INFORMATION FROM A REGISTRANT VIA A REGISTRAR'S WEBSITE,” which is hereby incorporated in its entirety by reference.

The Facilitator's website 105 may also warn the Entrepreneur 101 if an otherwise available domain name has already been trademarked and inform the Entrepreneur 101 of the types of goods and services covered by the trademark. The Facilitator's website 105 may have previously obtained sufficient trademark information to do this analysis and is thus searching its own database or the Facilitator's website 105 may access an external database, possibly the USPTO database, to check for potential trademark issues. Determining if a conflict exists between an otherwise available domain name and a trademark could help prevent the Entrepreneur 101 from later being sued for trademark infringement for the use of their domain name and will increase the Entrepreneur 101 chance in obtaining a trademark on the domain name by eliminating possible conflicts. After a domain name has been registered, the Facilitator's website 105 may suggest to the Entrepreneur 101 that the domain name should be trademarked, preferably via the tools offered by the Facilitator's website 105.

The art of designing and creating websites on the Internet is well known. Conventional websites are almost always written in HTML. Early website designers created their websites by writing HTML programs one line at a time. This method is still used by many website designers and allows for highly customized websites to be created. However, creating a website by writing each line of HTML code requires considerable programming expertise and a fairly long development time. Higher level programming languages have also been created to simplify the process and shorten the development time for creating websites.

Recent improvements to website development techniques allow websites to be created very quickly using templates. The flexibility in designing a website using a selected template is reduced, but the ease and simplicity more than make up for its lack of flexibility in many cases. For Example, The Go Daddy Group, Inc™, at www.GoDaddy.Com, offers website designing tools, such as Website Tonight™ and Website Complete®, to be used to design websites using a template system. Website designing tools may offer a large number of templates that a website designer may select from to use for a particular website. Each template may provide a different layout and appearance for a website to help the website display its information in a format most advantageous for that particular website.

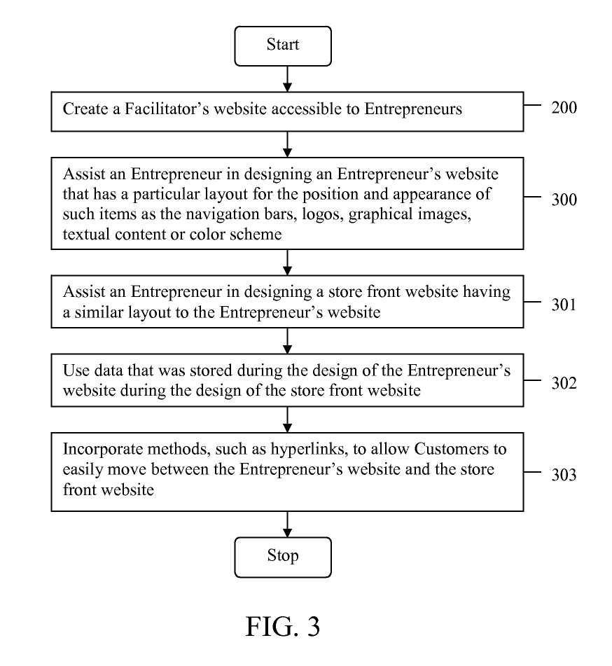

Once a template has been selected, as illustrated in FIG. 3, the selected template may be used for most or even all of the webpages in the website (Step 300). Basic information may be requested and received from the Entrepreneur 101, or online sources, and used throughout the website. A common template for most or all of the website pages gives a website a uniform appearance and greatly simplifies the website's design process. Templates may, as non-limiting examples, provide a uniform appearance and location for one or more of the navigation bars, logos, graphical images, special content as well as provide a uniform color scheme for the webpages within a website. A consistent look and feel for each webpage gives the website a professional appearance and assists Users in negotiating their way around the website (Step 203).

The website designing tools may also perform other functions for the website. For example, the website designing tools may add meta tags to the website to allow search engines to properly classify the website. The website designing tools may also perform spell checks for websites and may even have a built-in File Transfer Protocol (FTP) system. In addition, the Facilitator's website 105 may request information from the Entrepreneur 101 that may be stored for later use. As examples, contact information, billing information, company logos, etc. may be stored for later use so that the Entrepreneur does not have to keep entering this information for each step.

The focus for most Entrepreneurs 101 is to sell their goods and services and then receive payment from the Customer 100. This requires the goods and services to be displayed for the Customer 100, a method for the Customer 100 to select the goods and services they desire to purchase and a method for accepting payment from the Customer 100. While programming these basic electronic commerce features into the Facilitator's website 105 is certainly possible, it requires a substantial amount of website design time and expertise.

Entrepreneurs 101 may have Customers 100 send payments through the mail or allow a third party, such as PayPal, to take and process the payments. In a preferred embodiment, the Entrepreneur 101 may purchase access to a store front website 109 that offers electronic commerce features. These features may include a product catalog, order management system, third party payment integration, shipping integration, customer manager, reporting methods and tax collection methods. If an Entrepreneur 101 wants to accept credit cards on his store front website 109, the Entrepreneur 101 may purchase a merchant account, and, in order to process non-point-of-sale credit card transactions, interact with a payment gateway, such as Authorize.net, and apply for and receive a secure certificate. The Entrepreneur 101 may purchase these features as a bundled product that includes all of the necessary products to easily incorporate credit card and electronic check processing into their website 107. All of these may be integrated from the Facilitator's website 105. If the Entrepreneur 101 already has any of these payment components, the Entrepreneur may be able to use them in place of the Facilitator provided components.

A secure certificate allows the Entrepreneur 101 to exchange encrypted information with Customers 100. The secure certificate greatly reduces the chance a party not involved with the transaction between the Entrepreneur 101 and the Customer 100 will be able to get information about the transaction.

The store front website 109 may be customized and designed in a manner similar to the design of the Entrepreneur's website 107. Of particular advantage is to include common templates in the design tools for the Entrepreneur's website 107 and the design tools for the store front website 109 so that the same template may be used for both websites. This allows an Entrepreneur 101 to create an Entrepreneur's website 107 and a store front website 109 that have a similar layout and appear to be a single website from the Customer's perspective (Step 301). Specifically, the Entrepreneur's website 107 and the store front website 109 may share a similar appearance and location for a navigation bar, logos, graphical images, special content (such as textual messages), color scheme and other features. The more of these features that are shared between the Entrepreneur's website 107 and the store front website 109, the more the two websites will appear as a single website.

A single store front website 109 may be dedicated to each Entrepreneur's website 107. However, a much more efficient use of computer resources may be achieved by allowing a single store front website 109 to handle a plurality of different Entrepreneurs' websites 107. This may be accomplished by enabling the store front website 109 to detect which Entrepreneur's website 107 the Customer 100 came from and then displaying the store front website 109 using the template and data previously submitted by the Entrepreneur 101 for that Entrepreneur's website 107. This allows the store front website 109 to be customized by each Entrepreneur 101 and appear as if it were an integral part for a large number of different Entrepreneurs' websites (Step 204). The Facilitator's website 105 may also use information previously stored regarding the Entrepreneur 101 in designing the store front website 109 (Step 302).

Known methods, such as hyperlinks, may be used to allow Customers to easily move back and forth between the webpages in the Entrepreneur's website 107 and the webpages in the store front website 109 thereby creating a virtual website. Menu tabs, lists, links or other methods may also be used to assist Customers 100 in moving between the two websites (Step 303). The appearance of a single virtual website promotes confidence in the Customer 100 that they are purchasing goods and services from the Entrepreneur 101 and presents a professional appearance to the Customer 100.

A Hosting services 110 may also be offered to the Entrepreneur 101 for the Entrepreneur's website 107 on the Facilitator's website 105 (Step 205). The Facilitator's website 105 may ask questions of the Entrepreneur 101 in an attempt to determine a recommended level of hosting services. The recommendations may include suggestions regarding the amount of disk space, bandwidth, email accounts and database capabilities that will be provided for the Entrepreneur's website 107. The Facilitator's website 105 may compare past websites that are similar to the Entrepreneur's website 107 in determining and recommending a level of hosting services for the Entrepreneur's website 107. The resources provided by the hosting service 110 may be updated from time to time as the volume of the Entrepreneur's Internet business fluctuates. In a preferred embodiment, the resources are automatically updated to match the needs of the Entrepreneur's website 107, but an email message or other method of contacting the Entrepreneur 101 may also be used to let the Entrepreneur 101 know that a change in the allocated hosting service's resources is recommended. Hosting the Entrepreneur's website 107 effectively publishes the website 107 and puts the domain name in commercial use.

The Facilitator's website 105 may also be used to assist the Entrepreneur 101 in copyrighting all or some portion of the material comprising the Entrepreneur's website 107 with the United States Copyright Office 108 (Step 206). Information necessary to complete a copyright application may be requested and received either from the Entrepreneur 101, from available on-line databases or from information previously received from the Entrepreneur 101 and saved (Step 400). The copyright application information will typically include the title of the work (the domain name may be used as the default title), number of authors, names of authors, i.e. the designers of the Entrepreneur's website 107, whether the work made for hire, date of the author(s)' birth, authors' nationality or domicile, creation date, publication date, name and address of a claimant if there is one, nature of transfer if there is a claimant, nature of previous copyright registrations if any, nature of the work, i.e. whether it is a new work, derivation or compilation, name and contact information for a correspondent, certification from the author(s), address for return of the certificate and method of payment for the copyright fee.

The Facilitator's website 105 may also obtain the content of the Entrepreneur's website 107 so that the material may be submitted to the USCO 108 as part of the copyright process (Step 401). The Facilitator's website 105 may obtain the material to be copyrighted using several different methods. For example, the Entrepreneur 101 may directly provide a file to the Facilitator's website 105. The file may be in the correct format or the Facilitator's website 105 may have to translate the file into a format acceptable by the USCO (Step 402). In another embodiment, the Entrepreneur 101 may provide a URL or domain name for the Entrepreneur's website 107 and the Facilitator's website 105 may access the Facilitator's website 105 over the Internet to obtain a copy of the material to be copyrighted.

The Facilitator's website 105 may create a copyright application by combining the Entrepreneur's copyright application information and a copy of Entrepreneur's website 107 in a format suitable for submission to the USCO (Step 403). The Entrepreneur 101 may be given an option (Step 404) of allowing the Facilitator's website 105 to electronically submit the copyright application to the USCO (Step 405) or to receive a copy of the copyright application (either via traditional mail or by electronic mail) (Step 406) and then allowing the Entrepreneur 101 to file the signed copyright application directly with the United States Copyright Office (Step 407).

In a preferred embodiment, the label (the domain name minus the top-level domain) portion of their domain name and the domain name for the Entrepreneur's website 107 may be trademarked with the USPTO (Step 207). The label and the domain name may be trademarked by the Facilitator's website 105 at any time during the creation of the Entrepreneur's Internet business. However, there are advantages in waiting until after the domain name has been registered and the Entrepreneur's website 107 has been hosted, thereby placing the domain name in interstate commerce. Once the domain name has been used in interstate commerce, a Use in Commerce (Section 1(a)) trademark application may be filed. Trademarking the domain name prior to hosting, assuming the domain name has not been used in commerce using another method, requires an Intent to Use (Section 1(b)) trademark application to be filed. A Section 1(b) application requires a Statement of Use and a corresponding fee to be filed at a later date, thereby making the Section 1(b) process more complicated and expensive. However, the Section 1(b) process may also be used if the Entrepreneur wishes to reserve the trademark before using it in commerce.

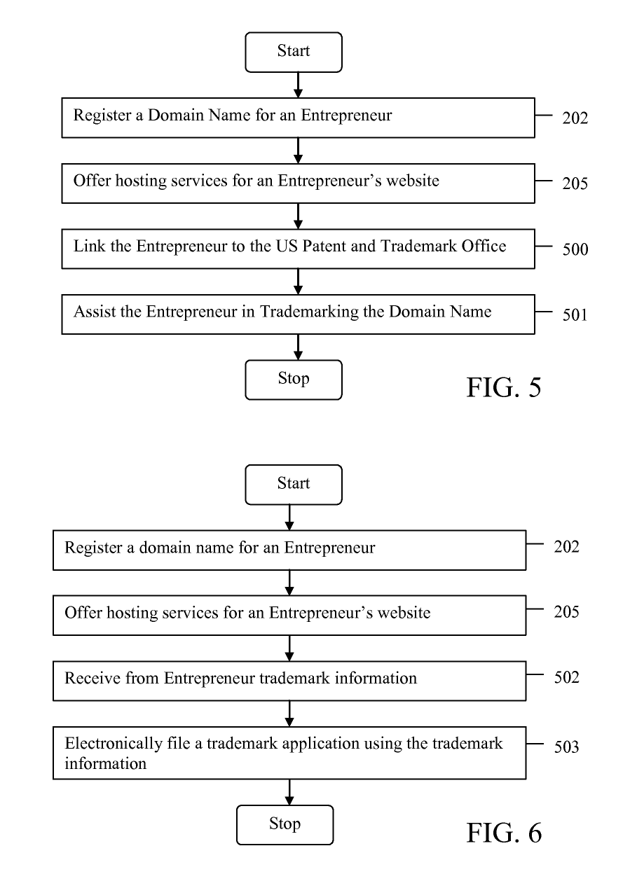

Several different methods may be used by the Facilitator's website 105 in assisting the Entrepreneur 101 in filing a trademark application for the domain name or the label with the USPTO 106. In a very streamlined embodiment specifically illustrated in FIG. 5, the Entrepreneur 101 may be given general guidance and instructions (Step 501) as to filing a trademark application and then provided a link from the Facilitator's website 105 to the USPTO's website 106 (Step 500). Once linked to the USPTO's website 106, the Entrepreneur 101 may follow the USPTO's instructions for filing a trademark application on the label and domain name. After trademarking their domain name, the Entrepreneur 101 may return to the Facilitator's website 105 to complete other steps for their Internet business.

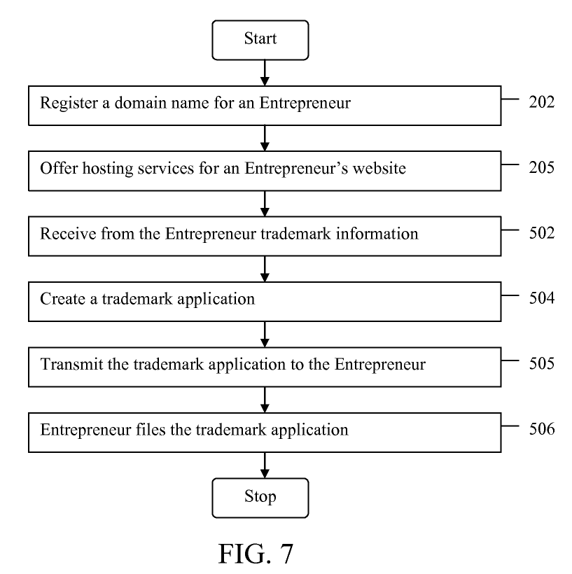

FIGS. 6-7 illustrate two other methods for the Facilitator's website 105 to assist the Entrepreneur 101 trademarking their domain name. The Facilitator's website 105 may request and receive trademark information from the Entrepreneur 101 that is necessary to file a trademark application (Step 502). The types of information necessary to file a trademark application are well known and publicly available on the USPTO's website at www.uspto.gov. Once the Facilitator's website 105 has the information, it may have a person manually enter the trademark information into the USPTO's website's online features. If the USPTO adds the capability for a direct website to website communication in the future, such as via an Application Program Interface (API), the trademark information may be automatically downloaded to the USPTO without human intervention (Step 503).

Another embodiment of the invention is for the Facilitator's website 105 to use the trademark information to create a trademark application (Step 504). The trademark application may be emailed to the Entrepreneur 101 (Step 505). The Entrepreneur 101 may then electronically sign the trademark application and email the trademark application to the USPTO (Step 506). Regardless of the trademark submission process, the trademark confirmation notice from the USPTO may be transmitted, for example by mail or email, to the Entrepreneur 101 for their records.

The Facilitator's website 105 may be used to increase traffic flow to the Entrepreneur's website 107 by analyzing, optimizing and submitting the Entrepreneur's website 107 to one or more search engines 104. The Facilitator's website 105 may accept search phrases and check the compatibility of the Entrepreneur's website 107 with the search phrases as well as check the textual content, parseability and spiderability of the Entrepreneur's website 107. In a preferred embodiment, the analysis mimics or uses similar ranking methodologies used by the search engines 104. The Facilitator's website 105 may then communicate suggested changes to the Entrepreneur 101 to be manually made or automatically change the Entrepreneur's website code so that the Entrepreneur's website 107 will be properly categorized and highly prioritized by search engines 104. The Facilitator's website 105 may then submit the Entrepreneur's website 107 and the store front website 109, including submitting individual webpages, to one or more search engines 104 (Step 208).

The search engine 104 submission process may be accomplished by the Facilitator's website 105, for example, using products similar to the product known as Traffic Blazer™ available from The Go Daddy Group, Inc. at the website of www.godaddy.com. Further details regarding the submission of websites to search engines 104 may be found in U.S. patent application Ser. No. 10/662,998 titled “METHOD FOR IMPROVING A WEBSITE'S RANKING WITH SEARCH ENGINES,” which is hereby incorporated by reference.

Customers 100 who purchase products from the Entrepreneur's store front website 109 may request to be sent sales and marketing information via email. The Entrepreneur 101 may use the Facilitator's website 105 to compile a list of Customers 100 for this purpose. The Entrepreneur 101 may then use complementary templates to construct the sales and marketing information that is sent to the Customers 100. The complementary templates for the sales and marketing information in the email may include a similar color schemes, logo, etc. to the templates used in creating the Entrepreneur's website 107 and store front website 109. The email containing the information may contain one or more embedded hyperlinks back to the Entrepreneurs' websites 107 or the store front website 109. This enables Customers 100 to transition seamlessly from the email to the Entrepreneur's website 107 or the store front website 109.

Performing various subcombinations of the above described steps on a Facilitator's website offers many advantages to Entrepreneurs 101. Such advantages include enabling Entrepreneurs 101 to perform a variety of different and complicated steps all from a single website to create their Internet business. This greatly simplifies the process and reduces the amount of time necessary to get the Entrepreneur's Internet business online and running. A single Facilitator's Website 105 also allows for a greater integration of steps than is possible in prior art methods of spreading the various Internet development tools over a plurality of websites. A single website also allows Entrepreneurs to access desired information all from a single website. In addition, Entrepreneurs only have to enter information a single time and then the information may be saved and used for later steps, greatly simplifying the otherwise burdensome task of entering and reentering data.

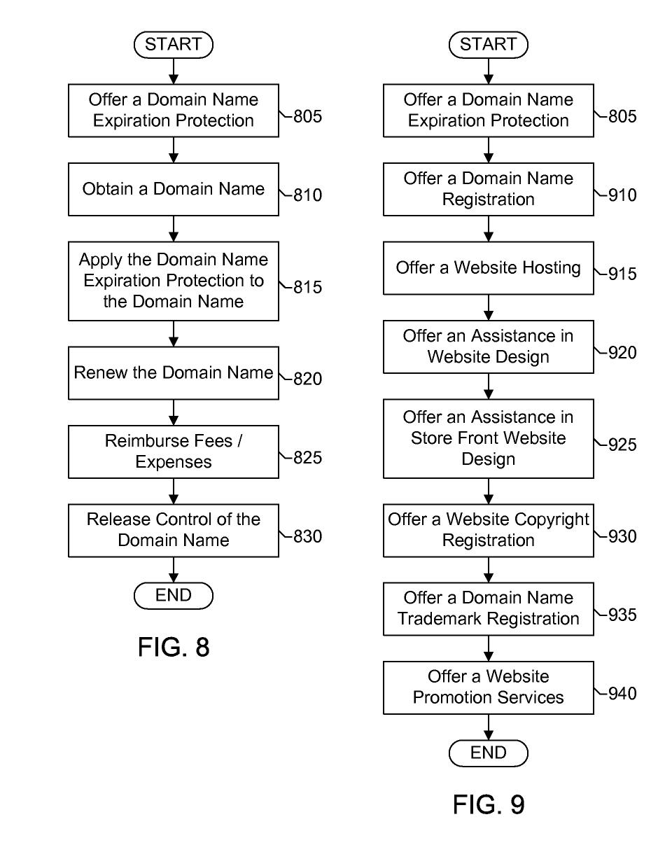

Referring to FIG. 8, the Facilitator may also offer domain name expiration protection (Step 805). The Entrepreneur 101 may obtain the domain name expiration protection from the Facilitator, while buying a domain name or at any point thereafter (Steps 810 and 815). The domain name expiration protection service may be offered for an additional fee or as a part of a package. If the Entrepreneur 101 did not renew the domain name and it expires, the Facilitator may renew the domain name (Step 820). No funds are withdrawn from the Entrepreneur 101 financial accounts at the point of domain name renewal. The domain name may be renewed in the name of the Entrepreneur 101 or in the name of another party, e.g. in the name of the Facilitator. If the domain name is renewed in the name of the Entrepreneur 101, the registrant's name and the contact information that were used to register the domain name may be used for the domain name renewal.

If the Entrepreneur 101 used a private registration for the domain name, such as Domains By Proxy® service from The Go Daddy Group, Inc., the renewal of the domain name may be completed using the same name and the contact information used for the private registration. Further details regarding the private registrations of domain names may be found in U.S. patent application Ser. No. 10/624,883 titled “METHOD AND SYSTEM FOR DOMAIN NAME REGISTRATION AND EMAIL BY PROXY,” which is hereby incorporated in its entirety by reference.

The Entrepreneur 101 may further reimburse the Facilitator for the renewal fees, private registration fees, or any other fees and/or expenses that may be encountered from the Facilitator's renewal of the domain name (Step 825). The Facilitator may hold the domain name as collateral until the Entrepreneur 101 pays any outstanding fees. The Facilitator may hold the domain name by locking it or registering it in its own name. After the fees due are paid, the Facilitator may release control of the domain name to the Entrepreneur 101 by unlocking it or transferring it to the Entrepreneur 101 (Step 830).

The Entrepreneur 101 may obtain the domain name expiration protection from the Facilitator independently of a domain name. Thus, the domain name expiration protection may be purchased in the form of credits, which may be applied towards the domain names of Entrepreneur's choice.

The domain name may be renewed by the Facilitator at any point in time including before the expiration of the domain name, after its expiration, during the redemption period, during the grace period, during the deletion period, etc. For example, the domain name may be renewed 60 days before its expiration if the Entrepreneur 101 has not yet renewed it.

As an option, the domain name expiration protection may be bundled with other services as described in this disclosure. Referring to FIG. 9, the domain name expiration protection may be combined with one or more services, such as domain name registration (Step 910), website hosting (Step 915), assistance in website design (Step 920), assistance in store front website design (Step 925), website copyright registration (Step 930), domain name trademark registration (Step 935), website promotion services (e.g. search engine submission) (Step 940), etc.

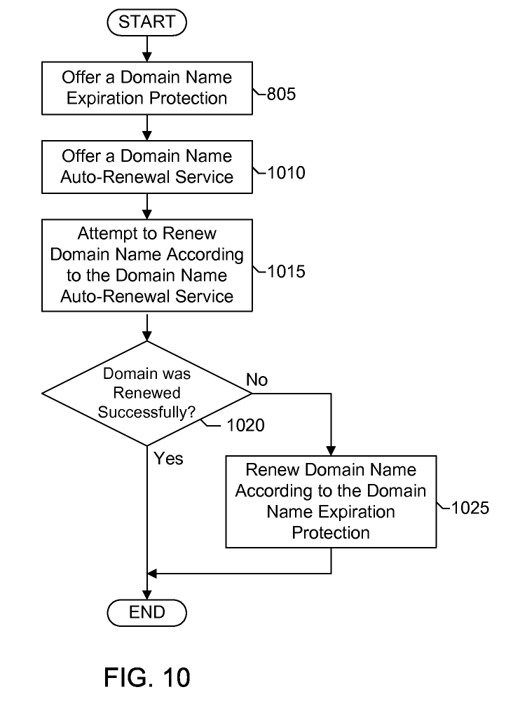

Additionally, the Facilitator may provide the Entrepreneur 101 with an auto-renewal service. If the domain name is not renewed by the Entrepreneur 101, the Facilitator may renew it automatically and optionally bill the Entrepreneur's stored financial account. Referring to FIG. 10, the Facilitator may offer domain name expiration protection (Step 805). The Facilitator may also offer a domain name auto-renewal service (Step 1010). The Facilitator may attempt to renew the domain name according to the domain name auto-renewal service (Step 1015), if attempt to renew was unsuccessful (Step 1020), then the Facilitator may renew the domain name according to the domain name expiration protection (Step 1025).

The auto-renewal service and the domain name expiration protection service may be offered as free or paid additional services or may be part of the general service agreement between the Facilitator and the Entrepreneur 101.

In view of the foregoing, it will be understood by those skilled in the art that the systems and processes of the present invention can facilitate the creation of an Internet business for an Entrepreneur and protect the Entrepreneur's domain names. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Such variations and modifications, however, fall well within the scope of the present invention as set forth in the following claims.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

The invention claimed is:

1. A method, comprising the steps of:
a) offering a domain name expiration protection service,
b) associating said domain name expiration protection service to a domain name, and
c) renewing said domain name according to said domain name expiration protection service.

2. The method of claim 1, further comprising a step of:
d) receiving a request to associate said domain name expiration protection service to said domain name.

3. The method of claim 1, further comprising a step of:
d) registering said domain name.

4. The method of claim 1, further comprising a step of:
d) transferring said domain name.

5. The method of claim 1, wherein said step c) comprises renewing said domain name in the name of an original registrant.

6. The method of claim 1, wherein said step c) comprises renewing said domain name in the name of a registrar.

7. The method of claim 1, wherein said step c) comprises renewing said domain name in the name of a third party.

8. The method of claim 1, wherein said step c) comprises renewing said domain name in the name of a proxy service.

9. The method of claim 1, further comprising a step of:
d) requesting reimbursement for said renewing said domain name.

10. The method of claim 1, further comprising a step of:
d) releasing control of said domain name to an original owner.

11. A method, comprising the steps of:
a) obtaining a domain name expiration protection service, and
b) associating said domain name expiration protection service to a domain name.

12. The method of claim 11, further comprising a step of:
c) obtaining said domain name.

13. The method of claim 11, further comprising a step of:
c) reimbursing a party maintaining said domain name expiration protection service for an expense associated with renewing said domain name.

14. The method of claim 11, further comprising a step of:
c) receiving back control of said domain name from a party maintaining said domain name expiration protection service.

15. A method, comprising the steps of:
a) offering a plurality of services, wherein said plurality of services includes a domain name expiration protection service, and
b) receiving a payment for said domain name expiration protection service.

16. The method of claim 15, wherein said plurality of services includes a domain name registration.

17. The method of claim 15, wherein said plurality of services includes a website hosting.

18. The method of claim 15, wherein said plurality of services includes offering assistance in website design.

19. The method of claim 15, wherein said plurality of services includes offering assistance in store front website design.

20. The method of claim 15, wherein said plurality of services includes offering a website copyright registration.

21. The method of claim 15, wherein said plurality of services includes offering a domain name trademark registration.

22. The method of claim 15, wherein said plurality of services includes offering a website promotion service.

23. A method, comprising the steps of:
a) offering a domain name auto-renewal service for a domain name,
b) offering a domain name expiration protection service for said domain name,
c) attempting to perform said domain name auto-renewal service for said domain name, and
d) if attempt to perform said domain name auto-renewal service for said domain name is unsuccessful, then performing said domain name expiration protection service for said domain name.

24. The method of claim 23, further comprising a step of:
e) registering said domain name.

25. The method of claim 23, further comprising a step of:
e) transferring said domain name.

26. A method, comprising the steps of:
a) a Facilitator offering a domain name expiration protection service on a Facilitator's website,
b) said Facilitator receiving a request from an Entrepreneur on said Facilitator's website for said domain name expiration protection service for a domain name, and
c) said Facilitator renewing said domain name after a registration of said domain name expires.

27. The method of claim 26, wherein said domain name is renewed during a grace period.

28. The method of claim 26, wherein said domain name is renewed during a redemption period.
